(19) United States
(12) Patent Application Publication
(10) Pub. No.: US 2016/0295827 A1
(43) Pub. Date: Oct. 13, 2016

(54) END EFFECTOR, ROBOT, AND ROTARY MILKING SYSTEM

(71) Applicant: DELAVAL HOLDING AB, Tumba (SE)

(72) Inventors: Thomas AXELSSON, Tumba (SE); Peter ERIKSSON, Tumba (SE); Tapani NIEMELA, Tumba (SE)

(21) Appl. No.: 15/100,368

(22) PCT Filed: Dec. 12, 2014
(86) PCT No.: PCT/SE2014/051494

§ 371 Date: May 31, 2016

(30) Foreign Application Priority Data
Dec. 18, 2013 (SE) 1351521-8

(51) Int. Cl. A01J 7/04; A01J 5/007; H04N 5/232; B25J 11/00; G06T 1/00; A01J 5/017; A01J 7/02

(52) U.S. Cl. CPC A01J 7/04; A01J 5/0175; A01J 5/007; A01J 7/025; B25J 11/008; G06T 1/0014; H04N 5/23229

(57) ABSTRACT

An end effector that mounts to a robot and discharges animal treating fluid onto the teats of a milking animal includes a rigid inner arm section and a flexible outer arm section, and a camera with a front window. An inner end portion of the inner arm section is mountable to the robot, the inner end portion of the outer arm section is rigidly connected to outer end portion of the inner arm section, the camera is mounted on an upper side of the inner arm section with the front window facing the outer arm section, and the outer arm section is provided with at least one nozzle in the outer end portion, the nozzle being directed upwards such that animal treating fluid can be discharged through the nozzle and upwards towards a teat of a milking animal during use of the robot.

### TECHNICAL FIELD OF THE INVENTION

The present invention relates generally to robot based discharging of fluid onto the teats of a milking animal, e.g. subsequent or prior to milking.

### DESCRIPTION OF RELATED ART AND BACKGROUND OF THE INVENTION

Milking systems with robots configured to discharge a post-milking treatment fluid onto the teats of milking animals after that the milking animals have been milked are known. Likewise, milking systems with robots configured to discharge a pre-milking treatment fluid onto the teats of milking animals before the milking animals have been milked are known.

Such robots comprises typically an end effector mounted to the robot and a camera mounted on the end effector, wherein nozzles, through which a treatment fluid can be discharged onto the teats of milking animals, are arranged in an outer end portion of the end effector. It shall be appreciated that the end effector, and particularly the outer end portion thereof, is operated in a harsh environment, wherein it may come into close contact with not only parts of the barn in which the milking system is installed, but also into close contact with the animals.

As a result, the end effector has to withstand not only dirt, animal faeces, various fluids, and possibly chemicals, such as cleaning chemicals, but also kicks from the milking animals and other mechanical stresses and strains Typically, such exposure to mechanical forces may lead to damages of the end effector, of the camera, or of the robot used.

### SUMMARY

It is therefore an aim to provide an end effector, which can withstand mechanical forces to an outer end portion thereof without the risk of damaging the end effector, the camera mounted thereon, or the robot itself, while still the camera should be well supported and protected and have constantly a well-defined position.

A first aspect refers to an end effector for a robot configured to discharge animal treating fluid onto the teats of a milking animal. The end effector comprises an inner arm section and an outer arm section, and a camera with a front window, wherein the inner arm section comprises an inner end portion and an outer end portion and the outer arm section comprises an inner end portion and an outer end portion. The inner end portion of the inner arm section is configured to be mounted to the robot, the inner end portion of the outer arm section is rigidly connected to outer end portion of the inner arm section, the camera is mounted on an upper side of the inner arm section with its front window facing the outer arm section, and the outer arm section is provided with at least one nozzle in the outer end portion, wherein the nozzle is directed upwards and is connectable to a source of animal treating fluid, such that animal treating fluid can be discharged through the nozzle and upwards towards a teat of a milking animal during use of the robot. The inner arm section is of a rigid material, whereas the outer arm section is of a flexible material.

Hereby, the camera can be rigidly mounted to a rigid part of the end effector, whereas the outer arm section of the end effector is of a flexible material. The camera may be heavy and may require the support of a rigid arm section. Further, it is important that the position of the camera with respect to the end effector is well known and is not changed. Mounting the camera on a flexible support would give an inexact position of the camera since the material of the flexible support flexes; it may be compressed, bent, or otherwise deformed. On the other hand, the outer arm section need only to carry one or more nozzles, and possibly one or more animal treating fluid supply lines, which are much lighter than the camera. If the outer arm section of the end effector is moved towards an object, an object is moved towards the outer arm section, or an animal hits the outer arm section, the outer arm section flexes and takes up the forces exposed to the end effector. As a result, the end effector, the camera, and/or the robot will be much less prone to damages as compared to an entirely rigid end effector. Still the rigid inner arm section provides sufficient steadiness, stability, and rigidity to the end effector.

It shall be appreciated that the inner and outer arm sections may be generally straight elongated parts which are connected to one another to form either a straight elongated end connector or an end connector wherein the outer arm section is slightly angled with respect to the inner arm section.

The outer arm section may be of a polymer material such as e.g. polyurethane.

In three different embodiments, the outer arm section is of a material having a hardness of between about 60 as measured in the durometer scale A and about 50 as measured in the durometer scale D, between about 70 as measured in the durometer scale A and about 40 as measured in the durometer scale D, and between about 80 as measured in the durometer scale A and about 30 as measured in the durometer scale D, respectively.

In four different embodiments, the outer arm section may have a material thickness of less than about 15 mm, 10 mm, or 8 mm, and may have a material thickness of between about 4 mm and about 10 mm, respectively.

The outer arm section may have a top portion and side walls along its length defining an interior space capable of housing an animal treating fluid supply line to the nozzle. The interior space may be uncovered underneath.

Two benefits are provided by such design. Firstly, connectors, adapters, and tubing to the nozzles can be arranged within the interior space, wherein they are protected from e.g. dirt and liquids existing in the milking system environment. Secondly, the design provides for a lightweight outer arm section with a minimum of material thickness, while the outer arm section is still steady and stiff enough to provide the actions in a fast and efficient manner.

The design and material choice of the outer arm section may be such that the outer arm section is more easily bendable when exposed to a vertically directed force than when being exposed to a horizontally directed force of the same magnitude.

This is advantageous if the most occurring unwanted contact between the end effector and an object or a milking animal is that a milking animal treads on the outer arm section or kicks the outer arm section predominantly in a vertical direction.

Example measures of the length of the outer arm section are in the range of about 200 to 700 mm.

The inner arm section may be of a heat conducting material such as e.g. a metal such as aluminum so that heat generated by the camera can be lead away from there.

In one embodiment, the outer arm section is provided with two, preferably only two, nozzles in the outer end portion, wherein the nozzles are directed upwards and are connectable to the source of animal treating fluid, such that animal treating fluid can be discharged through the nozzles and upwards towards a teat of a milking animal during use of the robot. The nozzles may be arranged diagonally separated from one another, wherein the nozzle located farthest from the inner arm section may be tilted backwards such that the nozzle is directed upwards and backwards, whereas the nozzle located closest to the inner arm section may be tilted forward such that the nozzle is directed upwards and forward. The nozzles may be tilted in parallel, but separated, planes. These planes are preferably parallel with a main extension of the outer arm section of the end effector.

The nozzles may be designed to each provide a conically shaped discharge of animal treating fluid with an opening angle of between about 5 and 50 degrees, between about 15 and 45 degrees, between about 20 and 40 degrees, or between about 25 and 35 degrees. The animal treating fluid should be discharged within the entire surface of the cone.

Through investigations, it has been found that the above design, while being fairly simple, provides for a highly efficient discharging of animal treating fluid onto the teats of a milking animal; it ensures that all surfaces of the teats of the milking animal will be covered by the fluid in a fast and efficient manner even when only using two nozzles for discharging animal treating fluid.

The outer arm section may be provided with an other nozzle in the inner end portion, wherein the other nozzle is directed towards the front window of the camera and is connectable to a source of window cleaning fluid, such that window cleaning fluid can be discharged through the other nozzle and towards the front window of the camera during cleaning thereof. Such cleaning of the front window of the camera may typically be performed between the each of the treatments of the milking animals (i.e. discharging cleaning fluid onto the teats thereof).

Additionally, the outer arm section may be provided with a drain in the inner end portion in front of the other nozzle arranged to drain any window cleaning fluid collected in front of the other nozzle.

In one embodiment, the end effector comprises an air ejector with an orifice arranged above the front window of the camera, wherein the orifice is directed towards the front window of the camera and is connectable to a source of air, such that air can be blown through the orifice and towards the front window of the camera to remove any present window cleaning fluid from there.

It has been found that by arranging the nozzle for the discharging of window cleaning fluid onto the front window of the camera below the camera and the air ejector for drying the front window of the camera above the camera, efficient cleaning and drying of the front window of the camera is enabled. It is thus sufficient with a single e.g. circularly shaped, orifice configured to blow air in order to efficiently and fastly dry the front window of the camera. The single orifice should be directed towards a central portion of the front window.

Additionally, a cap may be arranged above the camera to protect the same, wherein the air ejector includes one, two, or more orifices directed towards the cap and connectable to the source of air, such that air can be blown through the one, two, or more orifices and towards the cap to remove any present window cleaning fluid from there.

It has been found that by also drying the front end of the cap, the risk of having window cleaning fluid to drop or flow from the cap and down onto the front window of the camera is eliminated.

A second aspect refers to a robot comprising the end effector of the first aspect.

A third aspect refers to a rotary milking system having a rotating platform and the robot of the second aspect arranged outside the rotating platform.

The robot may configured to move the outer arm section to below the teats of a milking animal via the space between the rear legs of the milking animal before fluid is discharged upwards onto the teats of the milking animal.

In one embodiment, the robot is configured to discharge a post-milking treatment fluid onto the teats of each milking animal on the rotating platform that passes a working area of the robot after that the milking animal has been milked on the rotating platform.

In another embodiment, the robot is configured to discharge a pre-milking treatment fluid onto the teats of each milking animal on the rotating platform that passes a working area of the robot before the milking animal has been milked on the rotating platform.

A further aspect relates to the problem of covering the entire teats of the milking animals with the desired fluid. Some spray approaches have shown to be insufficient. There is also a constant demand of performing the discharging of animal treating fluid onto the teats of the milking animals very fastly, particularly when it is performed in a milking system, such as a rotary milking system, in a pre-treating or post-treating procedure.

To this end, there is provided an end effector for a robot configured to discharge animal treating fluid onto the teats of a milking animal. The end effector comprises an inner arm section and an outer arm section, and a camera with a front window. The camera is mounted on an upper side of the inner arm section with its front window facing the outer arm section, the outer arm section is provided with two, preferably only two, nozzles directed upwards and connectable to a source of animal treating fluid, such that animal treating fluid can be discharged through the nozzles and upwards towards a teat of a milking animal during use of the robot, and the nozzles are arranged diagonally separated from one another, wherein the nozzle located farthest from the inner arm section is tilted backwards such that the nozzle is directed upwards and backwards, whereas the nozzle located closest to the inner arm section is tilted forward such that the nozzle is directed upwards and forward.

The nozzles may be tilted in parallel, but separated, planes. These planes may be parallel with a main extension of the outer arm section of the end effector.

The nozzle located farthest from the inner arm section may be tilted backwards an angle from a vertical direction and the nozzle located closest to the inner arm section is tilted forward an angle from a vertical axis, wherein the angles are between about 10 and 45 degrees, or between about 20-35 degrees.

The nozzles may be designed to each provide a conically shaped discharge of animal treating fluid with an opening angle of between about 5 and 50 degrees, between about 15 and 45 degrees, between about 20 and 40 degrees, or between about 25 and 35 degrees. The animal treating fluid should be discharged within the entire surface of the cone.

It has been found that the above design, while being fairly simple, provides for a highly efficient discharging of animal treating fluid onto the teats of a milking animal; it ensures that all surfaces of the teats of the milking animal will be covered by the fluid in a fast and efficient manner even when only two nozzles for discharging animal treating fluid are used.

The inner and outer arm sections may be different sections of an arm in one piece, or they may be different pieces, which are rigidly connected to one another.

A yet further aspect relates to the cleaning of the front window of the camera and the subsequent drying thereof. In some approaches it may be difficult to remove any cleaning or washing fluid left on the front window in a fast and efficient manner.

To this end, there is provided an end effector for a robot configured to perform an animal related operation with respect to the teats of a milking animal, the end effector comprising an arm, a camera with a front window, a nozzle, and an air ejector, wherein the camera is mounted on an upper side of the arm with its front window facing an outer end portion of the arm; the nozzle is arranged on an upper side of the arm in front of the camera, is directed towards the front window of the camera, and is connectable to a source of window cleaning fluid, such that window cleaning fluid can be discharged through the nozzle and towards the front window of the camera during cleaning thereof; and the air ejector is provided with an orifice arranged above the front window of the camera, directed towards the front window of the camera, and connectable to a source of air, such that air can be blown through the orifice and towards the front window of the camera to remove window cleaning fluid from there.

It has been found that by arranging the nozzle for the discharging of window cleaning fluid onto the front window of the camera below the camera and the air ejector for drying the front window of the camera above the camera, efficient cleaning and drying of the front window of the camera is enabled. It is thus sufficient with a single e.g. circularly shaped, orifice configured to blow air in order to efficiently and fastly dry the front window of the camera. The single orifice should be directed towards a central portion of the front window.

The end effector may comprise a cap arranged above the camera to protect the same, wherein the air ejector may include at least an other orifice directed towards the cap and connectable to the source of air, such that air can be blown through the at least one further orifice and towards the cap to remove window cleaning fluid from there.

In one embodiment, the air ejector may include two other orifices directed towards the cap and being connectable to the source of air, such that air can be blown through the at least one further orifice and towards the cap to remove window cleaning fluid from there. The two other orifices may be directed generally in opposite directions.

The orifice(s) direct towards the cap and the orifice directed towards the front window of the camera may be essentially perpendicular to each other.

It has been found that by also drying the front end of the cap, the risk of having window cleaning fluid to drop or flow from the cap and down onto the front window of the camera is eliminated.

The inner and outer arm sections may be different sections of an arm in one piece, or they may be different pieces, which are rigidly connected to one another.

In one embodiment the end effector is aimed for a robot configured to attach the teat cups to the teats of a milking animal. Alternatively, the end effector is aimed for a robot configured to fetch teat cups and to attach the teat cups to the teats of a milking animal, wherein the end effector is provided with a teat cup gripper in the outer arm portion.

In another embodiment, the end effector is aimed for a robot configured to discharge animal treating fluid onto the teats of a milking animal, wherein the end effector comprises an inner arm section and an outer arm section; and the camera is mounted on an upper side of the inner arm section with its front window facing the outer arm section.

Further characteristics and advantages will be evident from the detailed description of preferred embodiments given hereinafter, and the accompanying FIGS. 1-9, which are given by way of illustration only.

### BRIEF DESCRIPTION OF THE DRAWINGS

FIGS. 1-2 illustrate, schematically, in top and side views, portions of a rotary milking system equipped with a robot according to one embodiment.

FIG. 3 illustrates, schematically, in exploded perspective view, an end effector according to one embodiment.

FIGS. 4-6 illustrate, schematically, in perspective, top, and cross-sectional side views, the end effector of FIG. 3 as assembled.

FIGS. 7-8 illustrate, schematically, in perspective and cross-sectional side views, an air ejector as comprised in the end effector of FIGS. 3-6.

FIG. 9 illustrates, schematically, in perspective view, an alternative embodiment of an end effector which can be used in the robot of FIGS. 1-2.

### DETAILED DESCRIPTION OF EMBODIMENTS

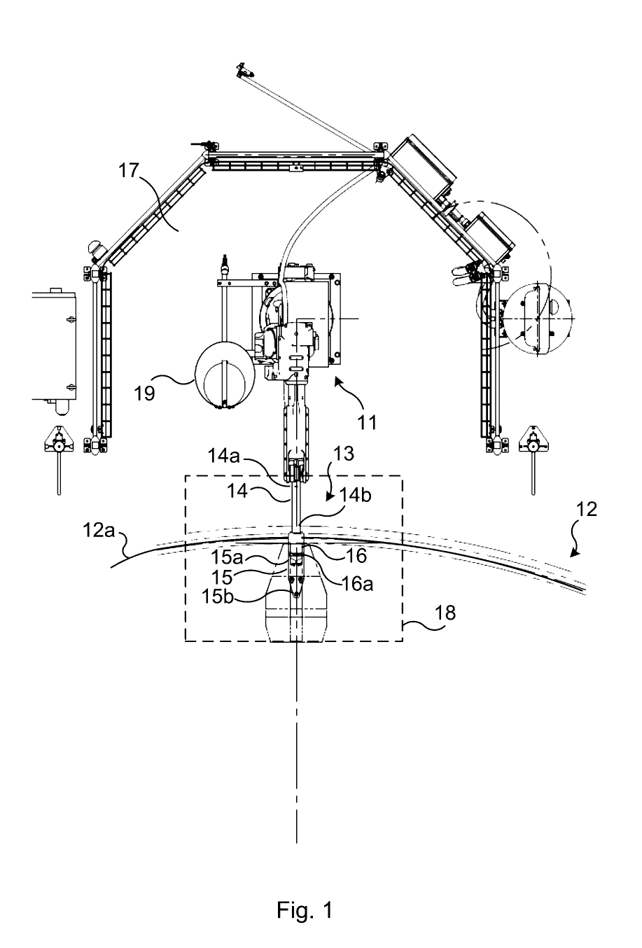

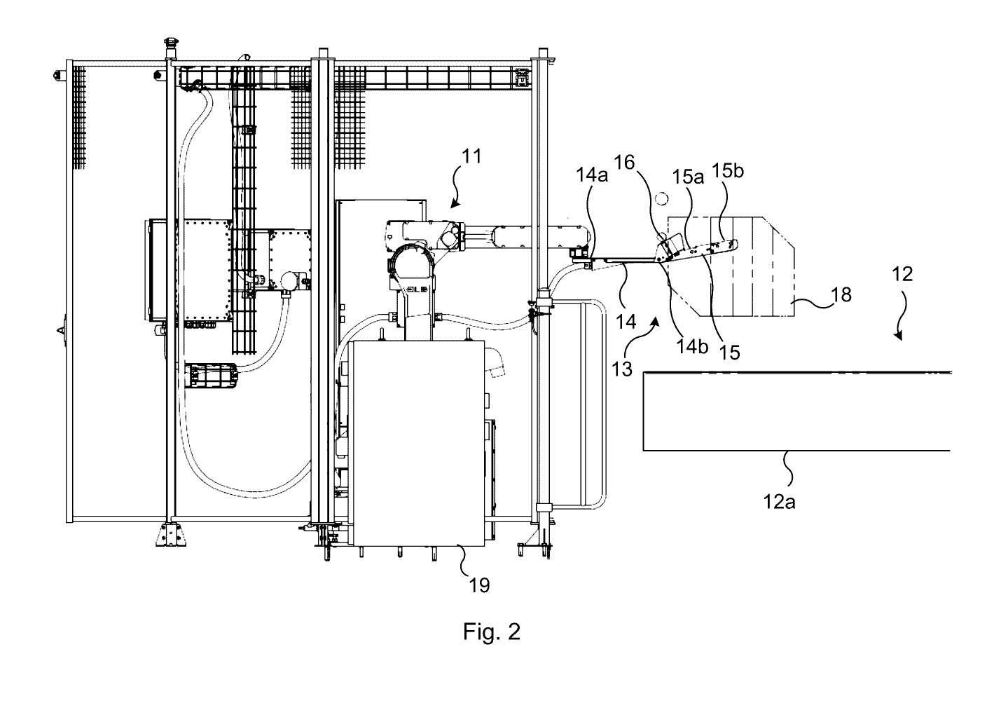

FIGS. 1-2 illustrate, schematically, in top and side views portions of a rotary milking system 12 equipped with a robot 11 according to one embodiment.

The rotary milking system 12 comprises a rotating platform 12a, on which the milking animals are standing while they are milked. The robot 11 is equipped with an end effector 13 comprising an inner arm section 14 and an outer arm section 15, and a camera 16 with a front window 16a. The inner arm section 14 comprises an inner end portion 14a and an outer end portion 14b and the outer arm section 15 comprises an inner end portion 15a and an outer end portion 15b, wherein the inner end portion 14a of the inner arm section 14 is mounted to the robot 11 and the inner end portion 15a of the outer arm section 15 is rigidly connected to outer end portion 14b of the inner arm section 14. Thus, the end effector 13 has the shape of an elongated straight or slightly angled arm mounted to the robot 11.

The camera 16 is mounted on an upper side of the inner arm section 14 with its front window facing the outer arm section 15. It may be a time-of-flight (TOF) camera and is configured to record images and to inform the robot 11 how it is moving the end effector 13. The robot can thus move the end effector in response to the images recorded by the camera 16.

The robot 11 is arranged in a robot area 17 outside the rotating platform 12a of the rotary milking system 12 and is operable within a working area 18 to discharge animal treating fluid onto the teats of a milking animal standing on the rotating platform 12a, e.g. with its back facing outwards. During such operation, the robot 11 may be configured to move the outer arm section 15 to below the teats of the milking animal via the space between the rear legs of the milking animal before fluid is discharged upwards onto the teats of the milking animal.

The robot 11 may be configured to discharge a post-milking treatment fluid onto the teats of each milking animal on the rotating platform 12a that passes the working area 18 of the robot 11 after that the milking animal has been milked on the rotating platform 12a. The robot area 17 and the working area 18 of the robot 11 may to this end be located at a position of the rotary milking system 12, wherein the milking of the milking animals has been terminated. Preferably, the robot area 17 and the working area 18 are located beside an area, at which the milking animals leave the rotating platform 12a, such that the milking animals will first pass the robot area 17 and the working area 18 and then reach the area, at which they leave the rotating platform 12a.

Alternatively, the robot 11 may be configured to discharge a pre-milking treatment fluid onto the teats of each milking animal on the rotating platform 12a that passes the working area 18 of the robot 11 before the milking animal has been milked on the rotating platform 12a. The robot area 17 and the working area 18 of the robot 11 may to this end be located at a position of the rotary milking system 12, wherein the milking of the milking animals has not yet been started. Preferably, the robot area 17 and the working area 18 are located beside an area, at which the milking animals enter the rotating platform 12a, such that the milking animals pass the robot area 17 and the working area 18 shortly after having entered the rotating platform 12a.

Further there is provided a cleaning device 19 for cleaning of the end effector. To this end, the robot moves the end effector to the cleaning device 19 for cleaning when needed or when scheduled, and the cleaning device 19 then cleans the end effector. Such cleaning may be performed a few times a day or more rarely.

It shall be appreciated that the end effector 13 is normally held more or less horizontally, so when terms as upper, lower, horizontal, vertical, and the like, they refer to such positioning of the end effector 13. Nevertheless, the robot 11 may in some situations, such as e.g. during cleaning by the cleaning device 19, hold the end effector 13 essentially vertically.

The inner arm section 14 of the end effector 13 is of a rigid material, whereas the outer arm section 15 is of a flexible material.

The outer arm section 15 may be of a material having a hardness of between about 60 as measured in the durometer scale A and about 50 as measured in the durometer scale D, between about 70 as measured in the durometer scale A and about 40 as measured in the durometer scale D, or between about 80 as measured in the durometer scale A and about 30 as measured in the durometer scale D.

The outer arm section 15 of the end effector may have a material thickness of less than about 15 mm, 10 mm, or 8 mm, or may have a material thickness of between about 4 mm and about 10 mm, and the outer arm section 15 may be designed such that it is more easily bendable when exposed to a vertically directed force than when being exposed to a horizontally directed force of the same magnitude.

The outer arm section 15 may be between about 200 and 700 mm long, whereas the inner arm section may be of a similar length or may be longer.

The inner arm section 14 of the end effector 13 may be of a heat conducting material such as e.g. a metal such as aluminum. Hereby, heat generated by the camera 16 can be lead away from there, and no heat sink structures are required to be mounted on the camera 16, which would be prone to collect dirt.

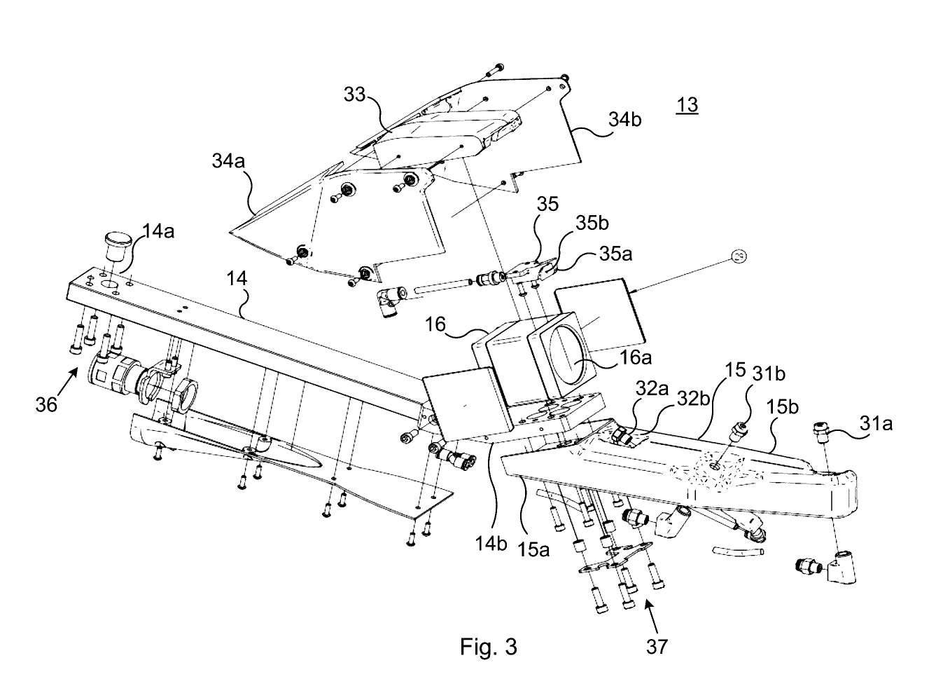

FIGS. 3-6 illustrate, schematically, the end effector of FIGS. 1-2 in greater detail.

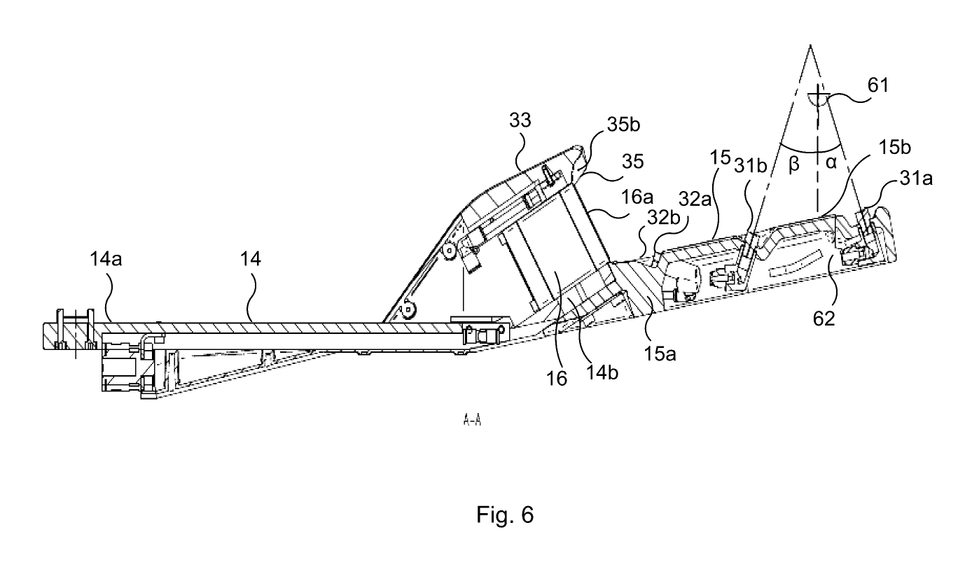

The outer arm section 15 is provided with two nozzles 31a-b in the outer end portion 15b, wherein the nozzles 31a-b are directed upwards and are connectable to a source of animal treating fluid, such that animal treating fluid can be discharged through the nozzles 31a-b and upwards towards a teat of a milking animal during use of the robot 11. In FIG. 6 the tip of a teat of a milking animal is denoted by reference numeral 61.

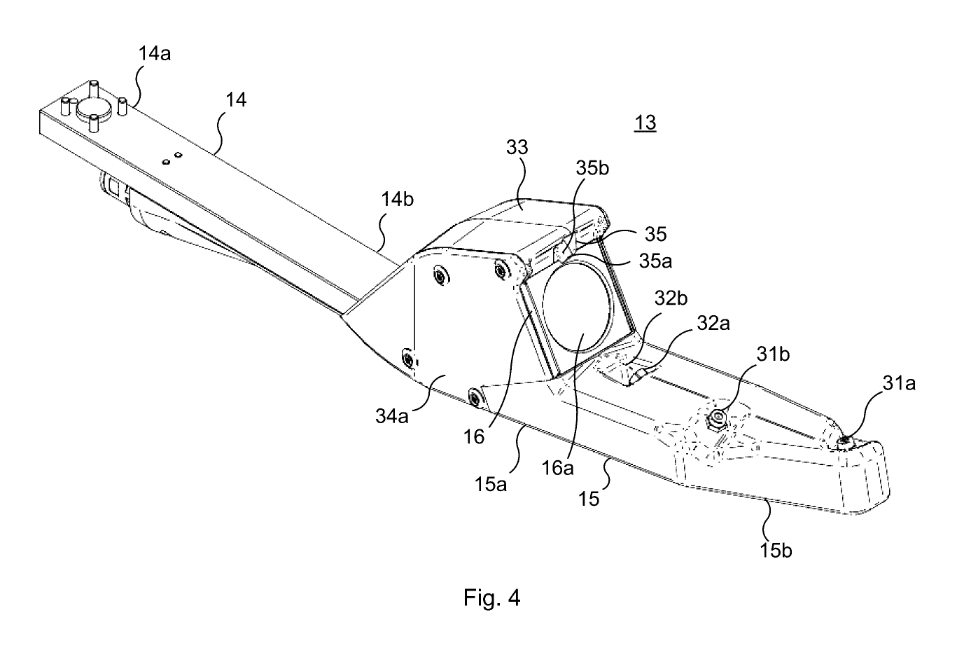

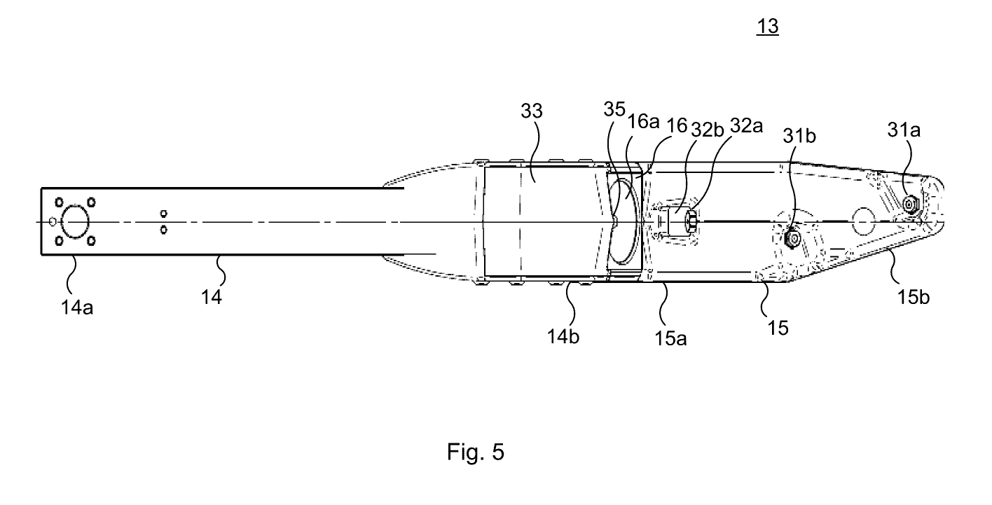

The nozzles are arranged diagonally separated from one another as can best be seen in FIGS. 4 and 5. The nozzle 31a located farthest from the inner arm section 14 (i.e. closest to the free end of the end effector 13) is tilted backwards an angle α as shown in FIG. 6, such that the nozzle is directed upwards and backwards. Similarly, the nozzle 31b located closest to the inner arm section 14 (i.e. most far away from the free end of the end effector 13) is tilted forward an angle β such that the nozzle is directed upwards and forward. The angles α and β may be between about 10 and 45 degrees, or even between about 20-35 degrees.

The nozzles 31a-b may be tilted in parallel, but separated, vertical planes.

The outer arm section 15 of the end effector 13 may be provided with an other nozzle 32a in the inner end portion 15a, wherein the other nozzle 32a is directed towards the front window 16a of the camera 16 and is connectable to a source of window cleaning fluid, such that window cleaning fluid can be discharged through the other nozzle 32a and towards the front window 16a of the camera 16 during cleaning thereof.

The outer arm section 15 may be provided with a drain 32b in the inner end portion 15a in front of the other nozzle 32a arranged to drain any window cleaning fluid collected in front of the other nozzle 32a. Alternatively, the other nozzle 32a is arranged on a protrusion or elevation of the outer arm section 15 so that no window cleaning fluid will be collected in front of the other nozzle 32a.

The outer arm section 15 of the end effector may be designed to have a top portion and side walls along its length defining an interior space 62 capable of housing an animal treating fluid supply line to the nozzles 31a-b. The design is best seen in FIGS. 4 and 6 and the interior space 62 is illustrated in FIG. 6. The interior space 62 may be uncovered or open underneath.

The end effector 13 may comprise a cap 33 arranged above the camera 16 and side covers 34a-b arranged on either sides of the camera 16 to protect the camera 16 from becoming dirty. The cap 33 may protrude in front of the camera 16.

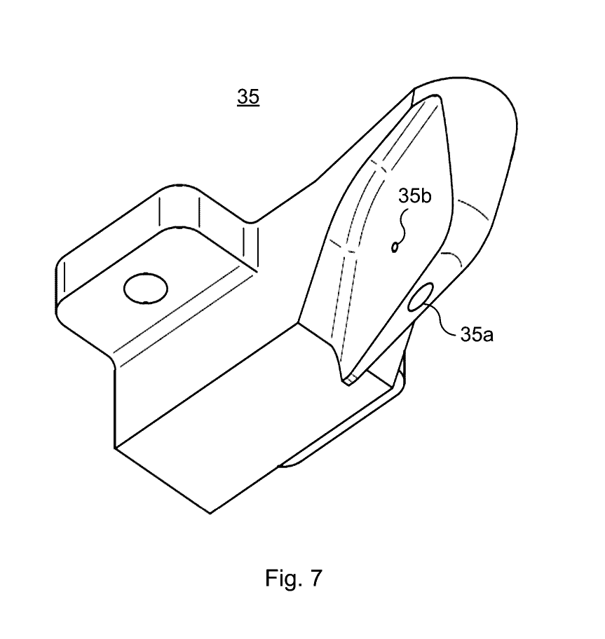

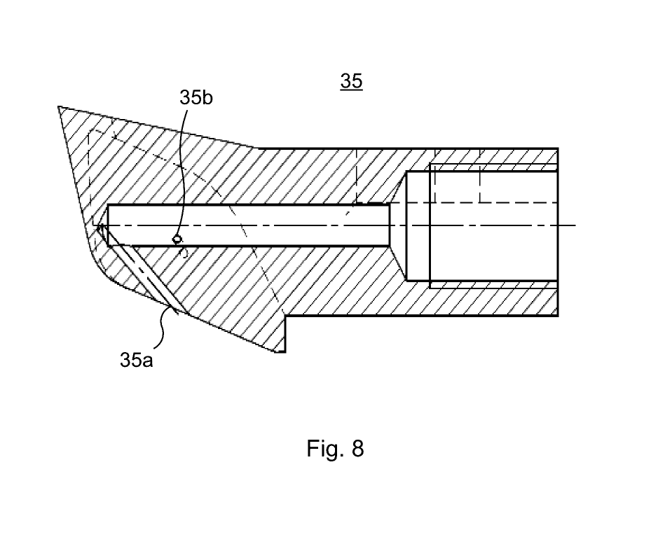

The end effector 13 may further comprise an air ejector 35 arranged in the front end of the cap 33. The air ejector 35 is provided with an orifice 35a arranged above the front window 16a of the camera 16, wherein the orifice 35a is directed towards the front window 16a of the camera 16 and is connectable to a source of air, such that air can be blown through the orifice 35a and towards the front window 16a of the camera 16 to remove window cleaning fluid from there. The air ejector 35 may further comprise two further orifices 35b directed towards the cap 33 and connectable to the source of air, such that air can be blown through the further orifices 35b and towards the cap 33 to remove window cleaning fluid from there. FIGS. 7-8 illustrate the air ejector 35 in greater detail.

In FIG. 3, various fasteners such as e.g. bolts or screws 36, 37 are illustrated for mounting the inner end portion 14a of the inner arm section 14 to the robot 11, for rigidly connecting the inner end portion 15a of the outer arm section 15 to the outer end portion 14b of the inner arm section 14, and for mounting the camera 16 on the upper side of the inner arm section 14. To this end various parts of the end effector are provided with holes or threaded holes.

Further, a number of adapters, tubing parts, covers, casings, fasteners, and connectors are illustrated in FIG. 3, which can be used in the end effector 13 and for connection of the end connector 13 to the sources of animal treating fluid, window cleaning fluid, and air.

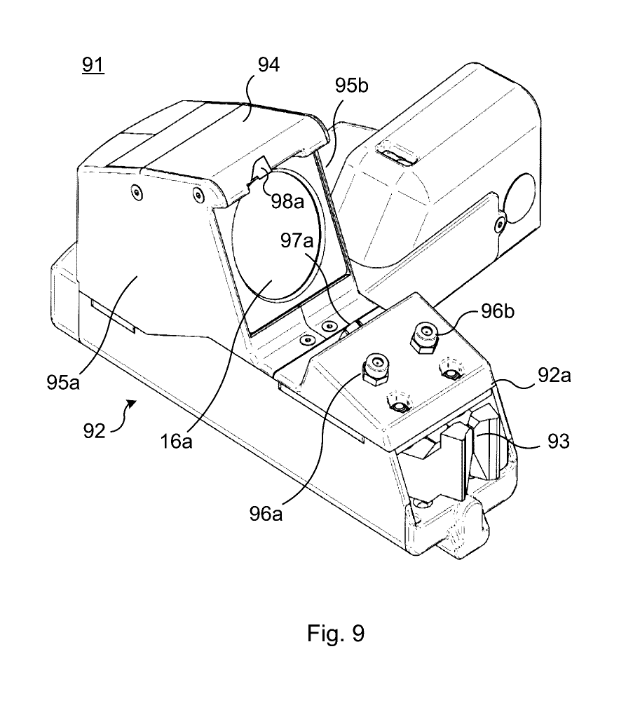

FIG. 9 illustrates, schematically, in perspective view, an alternative embodiment of an end effector 91 which can be used in the robot of FIGS. 1-2 to fetch teat cups of the rotary milking system 12 (or any other milking system such as e.g. an automated milking system for voluntary milking of milking animals) and to attach the teat cups to the teats of a milking animal which is to be milked.

The end effector 91 comprises an arm 92 and a camera with a front window 16a mounted on an upper side of the arm 92 with its front window 16a facing an outer end portion 92a of the arm 92. The camera may be identical to the camera disclosed with reference to FIGS. 1-8 such that the robot 11 can move the end effector 91 in response to images recorded by the camera. The end effector is provided with a teat cup gripper 93 in the outer end portion 92a of the arm 92 so that teat cups can be gripped. The teat cup gripper 93 may be a mechanical gripper, but is preferably a magnetic gripper capable of gripping teat cups by means of applying magnetic forces.

The end effector 13 may comprise a cap 94 arranged above the camera and side covers 95a-b arranged on either sides of the camera to protect the camera from becoming dirty. The cap 94 may protrude in front of the camera.

The arm 92 may be equipped with two nozzles 96a-b on an upper side of the arm 92 in the outer end portion 92b, wherein the nozzles 96a-b are directed upwards and are connectable to at least one source of animal treating fluid, such that one or more animal treating fluids can be discharged through the nozzles 96a-b and upwards towards a teat of a milking animal during use of the robot 11, e.g. prior to attaching a teat cup to that teat and/or after that teat has been milked. If the end effector is used for both pre-milking and post-milking treatment, one of the nozzles 96a-b may be connectable a source of animal treating fluid for pre-milking treatment and the other of the nozzles 96a-b may be connectable a source of animal treating fluid for post-milking treatment.

The arm 92 is equipped with a further nozzle 97a on an upper side of the arm 92 in front of the camera, wherein the further nozzle 97a is directed towards the front window 16a of the camera and is connectable to a source of window cleaning fluid, such that window cleaning fluid can be discharged through the further nozzle 97a and towards the front window 16a of the camera during cleaning thereof.

Further, the arm 92 is equipped with an air injector provided with an orifice 98a arranged above the front window 16a of the camera, preferably in the cap 94, directed towards the front window 16a of the camera, and connectable to a source of air, such that air can be blown through the orifice and towards the front window 16a of the camera to remove window cleaning fluid or any other liquid from there. The air ejector may be similar to the air injector 35 disclosed with reference to FIGS. 1-8.

It shall be appreciated that a number of adapters, tubing parts, covers, casings, fasteners, and connectors, such as some of those illustrated in FIG. 3, may be used in the end effector 91 and for connection of the end connector 91 to the sources of animal treating fluid, window cleaning fluid, and air.

The end effector aimed for a robot configured to fetch teat cups and to attach the teat cups to the teats of a milking animal may have a different design than the one disclosed above. It may for instance comprise two arm sections as the end effector disclosed with reference to FIGS. 1-8 or comprise any of the other appearances, measures, or features as disclosed with respect to FIGS. 1-8.

Further, it shall be appreciated that the end effector of FIG. 9 may be further modified to be used in a robot for perform any animal related operation with respect to the teats of a milking animal. To this end, the teat cup gripper 93 may be exchanged for any other tool or device.

It shall be appreciated by a person skilled in the art that the above disclosed embodiments, variants, and features may be combined to form further embodiments falling within the terms of the claims, and that any measures are purely given as example measures.

1-56. (canceled)

57. An end effector (13) for a robot (11) configured to perform an animal related operation with respect to a teat of a milking animal, the end effector comprising:
an arm (14, 15; 92) that mounts to the robot, the arm having an outer end portion (15b, 92a),
the arm (15) having a top portion connected to opposite side walls that extend along along a length of the arm (15, 92) and define an interior space (62) below the top portion and between the side walls; and
at least one nozzle located in the top portion at the outer end portion, the at least one nozzle extending into the interior space for connection to a fluid supply line and a discharge directed upward to allow fluid to be discharged upwardly through the at least one nozzle during use of said robot.

58. The end effector (13) of claim 57, wherein,
the arm (14, 15) is comprised of an rigid inner arm section (14) and a flexible outer arm section (15),
the inner arm section (14) is comprises an inner end portion (14a) that mounts to the robot and an outer end portion (14b),
the outer arm section (15) is more easily bendable when exposed to a vertically directed force of a first magnitude than when being exposed to a horizontally directed force of the first magnitude,
the outer arm section (15) includes the top portion connected to the opposite side walls, the side walls extending along along a length of the outer arm section (15) to define the interior space (62) and defining an inner end portion (15a) rigidly connected to outer end portion (14b) of the inner arm section and an outer end portion (15b), the outer end portion of the outer arm section (15) being the outer end portion of the arm,
the at least one nozzle is a teat-treatment nozzle and the fluid supply line is an animal treating fluid supply line, and
each teat-treatment nozzle (31a-b) is located in the top portion within the outer end portion (15b) of the outer arm section, each connection being located within the interior space (62) of the outer arm section (15), each discharge directed upward to allow animal treating fluid to be discharged through each teat-treatment nozzle towards the teat (61) of the milking animal during use of said robot.

59. The end effector (13) of claim 57, wherein the at least one nozzle is a window-cleaning nozzle, the window-cleaning nozzle arranged on an upper side of the arm forward of the camera, the window-cleaning nozzle being directed rearward towards the front window of the camera to discharge window cleaning fluid towards the front window of the camera, the window-cleaning nozzle extending into the interior space for connection to a window-cleaning fluid supply line that provides the window cleaning fluid, and further comprising:
a camera (16) mounted on an upper side of the arm, the camera having a front window facing the outer end portion (15b, 92a);
an enclosure (95a, 95b, 94) surrounding the camera; and
an air ejector mounted in the enclosure and positioned above the front window of the camera, the air ejector being provided with an orifice (35a; 97a) directed in a direction towards the front window of the camera to blow air to remove the window cleaning fluid from the front window of the camera, the air ejector extending into the enclosure for connection to a source of the air.

60. The end effector (13) of claim 58, further comprising:
a camera (16) mounted on an upper side of the inner arm section (14), the camera having a front window facing the outer arm section (15);
a window-cleaning nozzle arranged on the top portion of the inner end portion (15a) of the outer arm section (15) forward of the camera and rearward of the at least one teat-treatment nozzle (31a-b, 96a-b), the window-cleaning nozzle being directed towards the front window of the camera to discharge window cleaning fluid towards the front window of the camera, the window-cleaning nozzle extending into the interior space (62) for connection to a window-cleaning fluid supply line that provides the window cleaning fluid;
an enclosure (95a, 95b, 94) surrounding the camera; and
an air ejector positioned above the front window of the camera, the air ejector being provided with an orifice (35a; 97a) directed in a direction towards the front window of the camera to blow air to remove the window cleaning fluid from the front window of the camera, the air ejector extending into the enclosure for connection to a source of the air.

61. The end effector (13) of claim 59, wherein,
the enclosure includes a cap (33; 94) arranged above the camera to protect the camera,
the air ejector includes at least one further orifice (35b) directed in a direction towards the cap to blow the air towards the cap to remove the window cleaning fluid from the cap, the at least one further orifice being connectable to the source of air.

62. The end effector (13) of claim 60, wherein,
the enclosure includes a cap (33; 94) arranged above the camera to protect the camera,
wherein the air ejector includes at least one further orifice (35b) directed in a direction towards the cap to blow the air towards the cap to remove the window cleaning fluid from the cap, the at least one further orifice being connectable to the source of air.

63. The end effector (13) of claim 59, wherein,
the enclosure includes a cap (33; 94) arranged above the camera to protect the camera,
wherein the air ejector includes two further orifices (35b) directed in opposite directions towards the cap to blow the air towards the cap to remove the window cleaning fluid from the cap, the two further orifices being connectable to the source of air.

64. The end effector (13) of claim 60, wherein,
the enclosure includes a cap (33; 94) arranged above the camera to protect the camera,
wherein the air ejector includes two further orifices (35b) directed in opposite directions towards the cap to blow the air towards the cap to remove the window cleaning fluid from the cap, the two further orifices being connectable to the source of air.

65. The end effector (13) of claim 61, wherein,
the at least one further orifice (35b) directed in the direction towards to blow the air towards the cap and the orifice (35a) directed in the direction to blow the air towards the front window are perpendicular to each other.

66. The end effector (13) of claim 62, wherein,
the at least one further orifice (35b) directed in the direction towards to blow the air towards the cap and the orifice (35a) directed in the direction to blow the air towards the front window are perpendicular to each other.

67. The end effector (13) of claim 63, wherein,
the two further orifices (35b) directed in the opposite directions to blow the air towards the cap and the orifice (35a) directed in the direction to blow the air towards the front window are perpendicular to each other.

68. The end effector (13) of claim 64, wherein,
the two further orifices (35b) directed in the opposite directions to blow the air towards the cap and the orifice (35a) directed in the direction to blow the air towards the front window are perpendicular to each other.

69. The end effector (13) of claim 59, further comprising:
two teat-treatment nozzles (31a-b, 96a-b) located in the top portion at the outer end portion forward of the at least one window-cleaning nozzle, a first of the two teat-treatment nozzles (96a) being connectable to a first animal treating fluid supply line for a first animal treating fluid and a second of the two teat-treatment nozzles (96b) being connectable to a second animal treating fluid supply line for a first animal treating fluid.

70. The end effector (13) of claim 59, further comprising:
a teat cup gripper (93) located within the interior space of the arm, wherein,
the outer end portion (92a) of the arm (92) includes an opening, the teat cup gripper (93) extending into the opening so that teat cups can be gripped.

71. The end effector (13) of claim 61, further comprising:
a teat cup gripper (93) located within the interior space of the arm, wherein,
the outer end portion (92a) of the arm (92) includes an opening, the teat cup gripper (93) extending into the opening so that teat cups can be gripped.

72. The end effector (13) of claim 60, wherein
the at least one teat-treatment nozzle (31a-b) includes
i) a first rearward direct teat-treatment nozzle (31a), located in the top portion within the outer end portion (15b) of the outer arm section, and tilted to discharge the animal treating fluid upward and rearward towards the teat (61) of the milking animal during use of said robot, and
ii) a second forward direct teat-treatment nozzle (31b), located in the top portion rearward of the first rearward direct teat-treatment nozzle (31a), and tilted to discharge the animal treating fluid upward and forward towards the teat (61) of the milking animal during use of said robot.

73. The end effector (13) of claim 62, wherein
the at least one teat-treatment nozzle (31a-b) includes
i) a first rearward direct teat-treatment nozzle (31a), located in the top portion within the outer end portion (15b) of the outer arm section, and tilted to discharge the animal treating fluid upward and rearward towards the teat (61) of the milking animal during use of said robot, and
ii) a second forward direct teat-treatment nozzle (31b), located in the top portion rearward of the first rearward direct teat-treatment nozzle (31a), and tilted to discharge the animal treating fluid upward and forward towards the teat (61) of the milking animal during use of said robot.

74. The end effector (13) of claim 64, wherein
the at least one teat-treatment nozzle (31a-b) includes
i) a first rearward direct teat-treatment nozzle (31a), located in the top portion within the outer end portion (15b) of the outer arm section, and tilted to discharge the animal treating fluid upward and rearward towards the teat (61) of the milking animal during use of said robot, and
ii) a second forward direct teat-treatment nozzle (31b), located in the top portion rearward of the first rearward direct teat-treatment nozzle (31a), and tilted to discharge the animal treating fluid upward and forward towards the teat (61) of the milking animal during use of said robot.

75. The end effector (13) of claim 58, wherein the outer arm section (15) is of a material having a hardness of between 70 as measured in the durometer scale A and 40 as measured in the durometer scale D,

76. The end effector (13) of claim 58, wherein the outer arm section (15) is of a material having a hardness of between 80 as measured in the durometer scale A and 30 as measured in the durometer scale D.
